(19) United States
(12) Patent Application Publication
(10) Pub. No.: US 2009/0059555 A1
(43) Pub. Date: Mar. 5, 2009

(54) MOTOR CONTROL APPARATUS

(75) Inventors: Nobuyuki Namiki, Fukuoka (JP); Kenichi Sekioka, Fukuoka (JP)

Correspondence Address: SUGHRUE-265550, 2100 PENNSYLVANIA AVE. NW, WASHINGTON, DC, 20037-3213, US

(73) Assignee: KABUSHIKI KAISHA YASKAWA DENKI, Kitakyushu-shi (JP)

(21) Appl. No.: 11/910,745

(22) PCT Filed: Mar. 24, 2006
(86) PCT No.: PCT/JP2006/305924

§ 371 Date: Oct. 5, 2007

(30) Foreign Application Priority Data
Apr. 5, 2005 (JP) 2005-108492

(51) Int. Cl. G01D 11/28

(52) U.S. Cl. 362/29

(57) ABSTRACT

There is provided a motor control apparatus illuminating a character or a graduation of a switch setting portion (3) when an operator sets the switch setting portion (3), capable of facilitating to set and preventing erroneous setting by promoting an optical recognizability and capable of achieving small-sized formation.

A motor control apparatus includes light illuminating portions (11a), (11b) for illuminating the switch setting portion (3), a light illumination drive portion for driving the light illuminating portions (11a), (11b) and a control portion for controlling to drive and stop the light illumination drive portion for turning on and turning off the light illuminating portions (11a), (11b) based on a change in a set value of the switch setting portion (3).

### TECHNICAL FIELD

The present invention relates to a motor control apparatus for driving a motor by setting a control system constant or a driving instruction condition by a setting switch.

### BACKGROUND ART

A first background art motor control apparatus is attached with a name plate in a shape of a circular disk formed with section describing lines for sectioning by 12 in a radial direction (radius direction) by an angle of 30 degrees in a circumferential direction of an operation dial main body and 3 stages of section lines 14 in the circumferential direction for selecting a setting item by a rotational operation dial, determining a constant of a selecting item by a display by using a button switch, and enabling to operate simply and easy to understand by necessary minimum operation instruments (refer to, for example, Patent Reference 1). In this way, according to the background art motor control apparatus, by attaching the name plate described with the setting items or the operation items and a vicinity of the operation dial, normally frequently used parameters can extremely simply be changed and erroneous setting can be prevented.

Further, there is a motor control apparatus of a background art shown in FIG. 5 as a motor control apparatus for driving a motor by setting a control system constant or a driving instruction condition by a setting switch. FIG. 5 is an outlook view of a motor control apparatus of a second background art. In the drawing, numeral 1 designates a motor control apparatus, numeral 2 designates a case, numeral 3 designates a setting switch, numeral 4 designates a state display, numeral 5 designates an input/output connector, numeral 6 designates a detector connector, numeral 7 designates a power source connector, numeral 8 designates a motor connector, numeral 9 designates a heat radiator.

The input/output connector 5 is connected to a higher order apparatus (not illustrated), respective signal pins thereof are allocated with a sequence input/output signal and a driving instruction signal. The detector connector 6 is connected to an encoder (not illustrated), respective signal pins thereof are allocated with a position detecting signal and a power source to the encoder. The power source connector 7 is connected to an alternating or a direct current power source (not illustrated) to supply a power from the power source to the motor control apparatus 1. The motor connector 8 is connected to a motor (not illustrated) to supply a power from the motor control apparatus 1 to the motor in accordance with the driving instruction. The heat radiator 9 is fastened with a power element (not illustrated) mounted to an inverter portion (not illustrated) at inside of the motor control apparatus 1 for radiating heat constituting a power loss of the power element in accordance with a driving instruction.

The state display 4 displays a state of the motor control apparatus 1 for urging normal, alarm, abnormal to an operator. A signal color or dual color LED or 7 segments display or the like is mainly used for the state display 4. The setting switch sets a control constant of a position control system or a speed control system and sets a driving instruction condition inputted from a higher order apparatus. A switch of a simple setting type of a rotary switch or a dip switch or the like is used for the setting switch 3.

Next, a procedure of setting the setting switch 3 by the operator will be explained. FIG. 6(a) is a front view of the second motor control apparatus 1, FIG. 6(b) is a front view in a state of removing the case 2 of the second motor control apparatus 1. In the drawings, operation of a constituent element of a notation the same as that of FIG. 5 stays the same, and therefore, an explanation thereof will be omitted. A control portion (not illustrated) at inside of the motor control apparatus 1 is stored with a control constant table and a driving instruction condition table of a control system of a number in conformity with a number of graduations of the setting switch 3. An operator selects a condition in accordance with a control object or a driving instruction by setting the setting switch 3 before driving the motor control apparatus 1. After having been selected, a driving instruction as well as a sequence signal are inputted from the higher order control apparatus to the motor control apparatus 1 to drive the motor. Here, with regard to a control constant of a control system in driving the motor, the control constant can be changed from an initially set constant by resetting the setting switch 3 in accordance with a variation in a load or a disturbance in driving the motor.

Patent Reference 1: JP-A-2001-069763 (pages 2-3, FIG. 1)

### DISCLOSURE OF THE INVENTION

### Problems to be solved by the Invention

There is frequently a case in which an environment of installing the motor control apparatus of the background art is contained normally in a control disk or the like isolated from outside environment. Further, inside of the control disk is frequently insufficient in a brightness for the operator to look at the name plate at a vicinity of the operation dial and printed characters and graduations of the setting switch of the motor control apparatus.

Therefore, the first motor control apparatus of the background art poses a problem that when contained at inside of the control disk, the setting item or the operation item described on the name plate is difficult to look at. Similarly, also when the second motor control apparatus of the background art is contained at inside of the control disk, there poses a problem that the graduations of the setting switch are difficult to look at. Further, there also poses a problem that it is difficult to change the control constant of the control system in driving the motor, there is required a removing operation for changing settings against a load variation or a disturbance in driving the motor and uselessness is brought about.

Further, according to the first and the second motor control apparatus of the background art, there poses a problem that when contained at inside of the control disk, an optical recognizability is deteriorated, and therefore, an erroneous setting is caused.

The invention is carried out in view of the problems and it is an object thereof to provide a motor control apparatus capable of illuminating graduations of a setting switch by providing a light illuminator at a vicinity of the setting switch, capable of promoting an optical recognizability, small-sized and easy to operate.

### Means for Solving the Problems

In order to resolve the above-described problems, the invention is constituted as follows.

According to claim 1, there is provided with a motor control apparatus including:

a switch setting portion for setting to switch a control constant of a control system in a motor or a driving instruction condition from outside to control a motor on the basis of a set value thereof;

a light illuminating portion for illuminating the switch setting portion;

a light illumination drive portion for driving the light illuminating portion; and

a control portion for controlling to drive and stop the light illumination drive portion.

According to claim 2, there is provided with the motor control apparatus according to claim 1, wherein

the control portion outputs a control signal to the light illumination drive portion based on a change in a set value of the switch setting portion.

According to claim 3, there is provided with the motor control apparatus according to claim 1, wherein

the control portion outputs a control signal of driving the light illumination drive portion during a previously set confirming time period immediately after inputting a power source of the motor control apparatus; and

the control signal for stopping the light illuminating portion is outputted after an elapse of the confirming time period.

According to claim 4, there is provided with the motor control apparatus according to claim 1, wherein

the control portion outputs a control signal for driving the light illumination drive portion during a previously set confirming time period after sensing a change in the set value of the switch setting portion; and

the control signal for stopping the light illuminating portion is outputted after an elapse of the confirming time period.

According to claim 5, there is provided with the motor control apparatus according to claim 1, wherein

the light illuminating portion is disposed at a vicinity of the switch setting portion for facilitating to see a character or a graduation.

According to claim 6, there is provided with the motor control apparatus according to claim 1, wherein

the light illuminating portion is disposed in front of a face of printing a character or a graduation of the switch setting portion.

According to claim 7, there is provided with the motor control apparatus according to claim 1, wherein

the light illuminating portion is disposed at a position which is not seen directly from a front face of the motor control apparatus.

According to claim 8, there is provided with the motor control apparatus according to claim 1, wherein

respective single pieces or pluralities of pieces of the light illuminating portions and the light illumination drive portions are provided for a number of the switch setting portions.

### EFFECTS OF THE INVENTION

According to the invention described in claim 1, when an operator sets the switch setting portion, the switch setting portion is illuminated by the light illuminating portion, and therefore, an optical recognizability by setting can be promoted, and an erroneous setting can be avoided.

According to the invention described in claim 2, only when the operator sets the switch setting portion, the switch setting portion is illuminated by the light illuminating portion, and therefore, a useless operation can be saved by avoiding the light illumination when not needed, further, a loss of the light illumination drive portion can be reduced, and conservation of energy can be achieved.

According to the invention described in claim 3, as a check before starting operation, setting of the switch setting portion at a current time point can be confirmed before conducting electricity to the motor by a driving instruction, and destruction of a motor drive system or wild run of the motor by erroneous setting can be prevented beforehand. Further, after confirming the setting, the light illuminating portion is turned off, and therefore, a useless operation can be saved such that the light illumination when not needed is avoided. Further, the loss of the light illumination drive portion can be reduced, and the conservation of energy can be achieved. Further, there is also achieved an effect of urging the starting operation per se to the operator.

According to the invention described in claim 4, when the operator sets the switch setting portion, the switch setting portion is illuminated by the light illuminating portion, and therefore, the optical recognizability in setting can be promoted, the destruction of the motor drive system and reckless driving of the motor by the erroneous setting can be prevented beforehand. Further, after confirming the setting, the light illuminating portion is turned off, and therefore, a useless operation can be saved such that light illumination when not needed is avoided, further, the loss of the light illumination drive portion can be reduced, and the conservation of energy can be achieved.

According to the invention described in claim 5, the optical recognizability in setting the switch setting portion can be promoted, erroneous setting can be avoided, and the small-sized formation of the motor control apparatus per se can be achieved.

According to the invention described in claim 6, the optical recognizability in setting the switch setting portion can further be promoted. Further, even in the light illuminating portion having a small illuminance, the optical recognizability in setting the switch setting portion can be promoted, and erroneous setting can be avoided.

According to the invention described in claim 7, a leakage of a brightness of the light illuminating portion to outside can be reduced, and the optical recognizability in setting the switch setting portion can further be promoted.

According to the invention described in claim 8, the numbers of the light illuminating portions and the light illumination drive portions can be reduced as less as possible and low cost formation of the motor control apparatus can be achieved. Further, by widening a degree of freedom of the number of the switch setting portions, the numbers of the light illuminating portions and the light illumination drive portions can be adjusted in accordance with sizes or the characters and graduations of the switch setting portion or the function of the switch setting portion.

### BRIEF DESCRIPTION OF THE DRAWINGS

FIG. 1 is a front view of a state of removing a case of a motor control apparatus showing a first embodiment of the invention.

FIG. 2 is a constitution block diagram showing the first embodiment of the invention.

FIG. 3 is a flowchart showing the first embodiment of the invention.

FIG. 4 is a front view of a state of removing a case of a motor control apparatus showing a second embodiment of the invention.

FIG. 5 is an outlook view of a second background art motor control apparatus.

FIG. 6(a) is a front view of the second motor control apparatus, FIG. 6(b) is a front view of a state of removing a case of the second motor control apparatus.

### DESCRIPTION OF REFERENCE NUMERALS AND SIGNS

1 motor control apparatus
2 case
3 setting switch
3a constant setting switch
3b condition setting switch
4 state display
5 input/output connector
6 detector connector
7 power source connector
8 motor connector
9 heat radiator
10 board
11a, 11b light illuminators
12 light illumination drive portion
13 control portion
14 inverter portion
101 alternating current power source
102 motor
103 encoder

### BEST MODE FOR CARRYING OUT THE INVENTION

An embodiment of the invention will be explained in reference to the drawings as follows.

### Embodiment 1

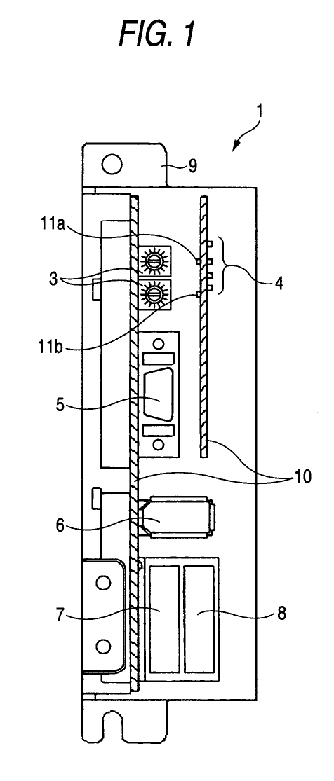

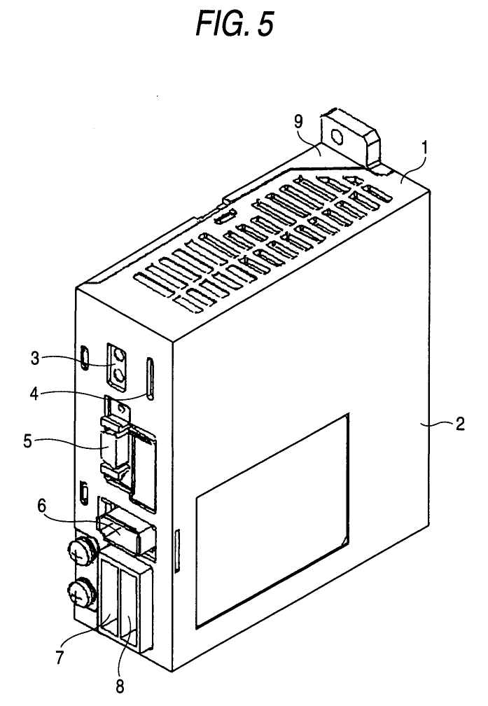

FIG. 1 is a front view of a state of removing a case of a motor control apparatus showing a first embodiment of the invention. In the drawing, numeral 1 designates the motor control apparatus, numeral 3 designates the setting switch, numeral 4 designates the state display, numeral 5 designates the input/output connector, numeral 6 designates the detector connector, numeral 7 designates the power source connector, numeral 8 designates the motor connector, numeral 9 designates the heat radiator, numeral 10 designates the board, numerals 11a, 11b designate the light illuminators. Further, an outlook of the motor control apparatus 1 is covered by the case 2 to constitute a cabinet thereof similar to the second background art of FIG. 5. The input/output connector 5 is connected to a higher order apparatus (not illustrated) and respective signal pins thereof are allocated with a sequence input/output signal and a driving instruction signal. The detector connector 6 is connected to an encoder (not illustrated) and respective signal pins thereof are allocated with a position detecting signal or a power source to the encoder. The power source connector 7 is connected to an alternating current or a direct current power source (not illustrated) to supply power from a power source to the motor control apparatus 1. The motor connector 8 is connected to a motor (not illustrated) to supply a power from the motor control apparatus 1 to the motor in accordance with a driving instruction. The heat radiator 9 is fastened with a power element (not illustrated) mounted to an inverter portion (not illustrated) at inside of the motor control apparatus 1 for radiating heat constituting a power loss of the power element in accordance with a driving instruction.

The state display 4 displays a state of the motor control apparatus 1 to urge normal, alarm, abnormal to an operator. A single color or a dual color LED or a 7 segments display or the like is mainly used for the state display 4. The setting switch 3 sets a control constant of a position control system or a speed control system, or sets a driving instruction condition inputted from the higher apparatus. A switch of a simple setting type of a rotary switch, a dip switch or the like is used for the setting switch 3. The board 10 is constituted by a control board mounted with the state display 4 and a control portion (not illustrated) and a power board mounted with the setting switch 3 and the inverter portion. The control board and the power board are connected by way of a connector (not illustrated) mounted to both thereof.

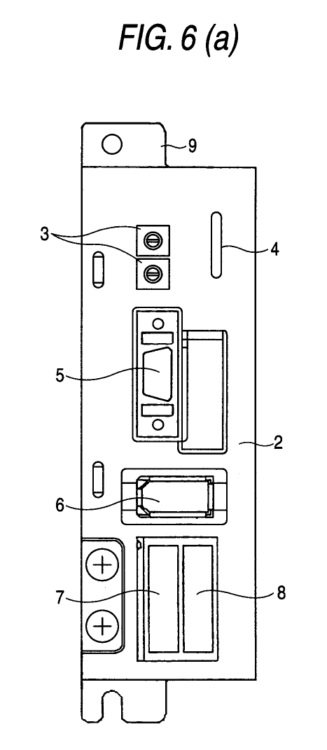

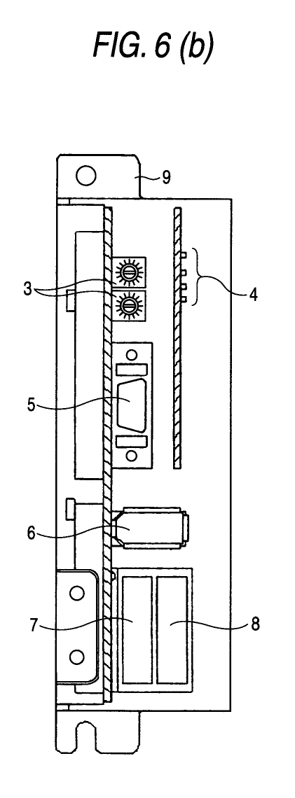

The light illuminators 11a, 11b are mounted to a solder face of the control board mounted with the state display 4 and mounted to be disposed in front of a graduation printing face of the setting switch 3 to facilitate to see graduations of the setting switch 3. Further, a front view of the motor control apparatus 1 is covered by the case 2 to constitute a cabinet thereof similar to the second background art of FIG. 6(a). In this case, by arranging the light illuminators 11a, 11b at positions which are not directly seen from a front face, leakage of brightness of the light illuminators 11a, 11b to outside is reduced to further facilitate to see graduations of the setting switch 3. Further, a necessary brightness of the illuminators is also ensured by adjusting a number of mounting the illuminators as necessary. Further, the illuminators 11a, 11b may be arranged not to be disposed in front of the graduation printing face of the setting switch 3 so far as an illuminance of the light illuminators 11a, 11b is sufficient for facilitating to see the graduations of the setting switch 3.

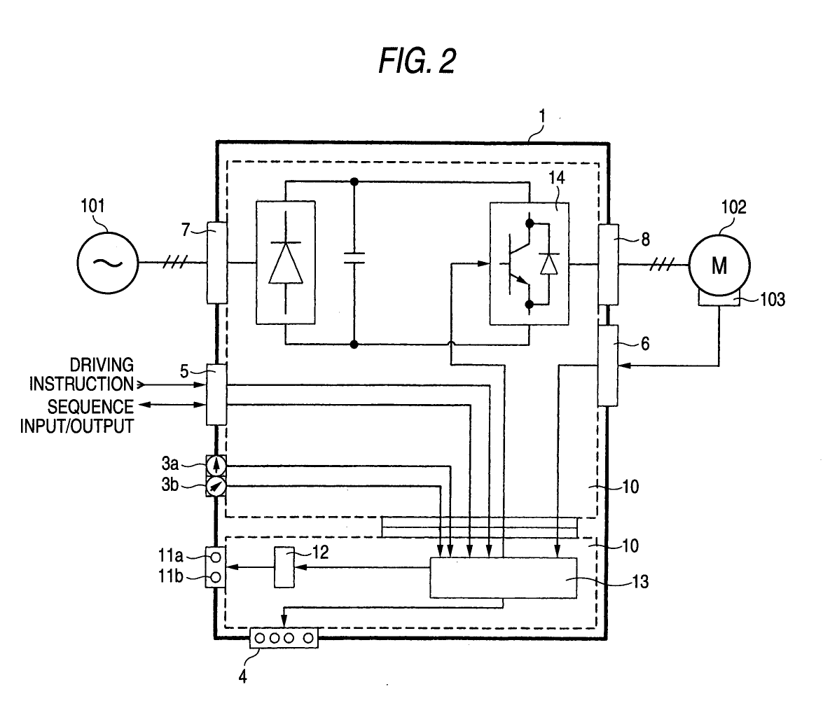

FIG. 2 is a constitution block diagram showing a first embodiment of the invention. In the drawing, notation 3a designates the constant setting switch for setting a control constant of the control system, notation 3b designates the condition setting switch for setting a driving instruction condition, numeral 12 designates the light illumination drive portion, numeral 13 designates the control portion, numeral 14 designates the inverter portion, numeral 101 designates the alternating current power source, numeral 103 designates the encoder. In the drawing, constituent elements of notations the same as those of FIG. 1 stay the same in operations, and therefore, an explanation thereof will be omitted. The light illumination drive portion 12 is constituted by a transistor or a photocoupler capable of driving the light illuminators 11a, 11b by a control signal from the control portion 13 and is mounted on both or either of the control board or the power board. Further, the power illumination drive portions and the light illuminators may be provided for the respective setting switches to individually control the light illuminators. Further, the control portion 13 may serve to operate to control in controlling the motor and drive the light illumination drive portion 12, or may be provided for driving the light illumination drive portion 12 separately from the control operation.

That the invention differs from the first, the second motor control apparatus of the background art resides in providing the light illuminators 11a, 11b and the light illumination drive portion 12, further, also a method of controlling the light illuminators 11a, 11b for turning on and turning off the light illuminators 11a, 11b by the control portion 13 by way of the light illumination drive portion 12 differs therefrom.

Next, a procedure of setting the setting switch 3 by the operator will be explained. The control portion 13 at inside of the motor control apparatus 1 is stored with a control constant table and a driving instruction condition table of a control system of a number in conformity with a number of graduations of the setting switches 3a, 3b. The operator selects a condition in accordance with a control object or in accordance with a driving instruction by setting the setting switches 3a, 3b before driving the motor control apparatus 1. After having been selected, a driving instruction as well as a sequence signal are inputted from the higher order control apparatus to the motor control apparatus 1 to drive the motor. Here, with regard to a control constant of the control system in driving the motor, the control constant can be changed from an initial set constant by resetting the constant setting switch 3a in accordance with a variation in a load or a disturbance in driving the motor.

Next, an explanation will be given of a method of controlling to turn on and turn off the illuminators 11a, 11b by the control portion 13 by way of the illumination drive portion 12. Basically, the control portion 13 always monitors changes in the setting switches 3a, 3b, when changes in the setting switches 3a, 3b by the operator are sensed, the illuminators 11a, 11b are turned on by driving the light illumination drive portion 12, further, when there are not the changes in the setting switches 3a, 3b by the operator, the illumination drive portion 12 is stopped and the illuminators are turned off.

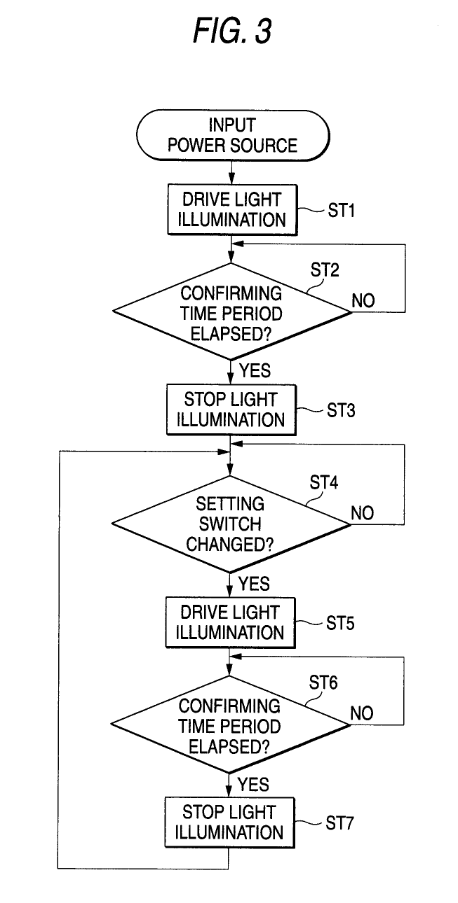

FIG. 3 is a flowchart showing the first embodiment of the invention.

(ST1) When the power source of the motor control apparatus 1 is inputted, the control portion 13 unconditionally drives the light illuminance drive portion 12 to turn on the light illuminators 11a, 11b and proceeds to step ST2.
(ST2) It is determined whether a previously set confirming time period has elapsed. When the confirming time period has not been elapsed, the operation awaits for the elapse of the confirming time period, when the confirming time period has elapsed, the operation proceeds to step ST3. Here, the confirming time period is previously set and the elapse is determined by counting up time at inside of the control portion 13. Further, the confirming time period is a time period sufficient for the operator to confirm graduations of the setting switches 3a, 3b.
(ST3) The control portion 13 turns off the light illuminators 11a, 11b by stopping the light illumination drive portion 12 and proceeds to step ST4.
(ST4) It is determined whether the setting switches 3a, 3b have been changed. When the setting switches 3a, 3b have not been changed, the setting switches 3a, 3b are continued to monitor, when the setting switches 3a, 3b have been changed, the operation proceeds to step ST5. Here, when both or either of the constant setting switch 3a, and the condition setting switch 3b is changed, it is determined that the switches 3a, 3b have been changed.
(ST5) The control portion 13 turns off the light illuminators 11a, 11b by driving the light illumination drive portion 12 and proceeds to step ST6.
(ST6) It is determined whether the previously set confirming time period has elapsed. When the confirming time period has not been elapsed, the operation awaits for the elapse of the confirming time period, when the confirming time period has elapsed, the operation proceeds to step ST7. Here, the confirming time period is previously set and the elapse is determined by counting up time at inside of the control portion 13. Further, the confirming time period is a time period sufficient for the operator to confirm graduations of the setting switches 3a, 3b. Further, the confirming time period may be the same as or different from the confirming time period at step ST2.
(ST7) The control portion 13 turns off the light illuminators 11a, 11b by stopping the light illumination drive portion 12 to continue to monitor the setting switches 3a, 3b again.

### Embodiment 2

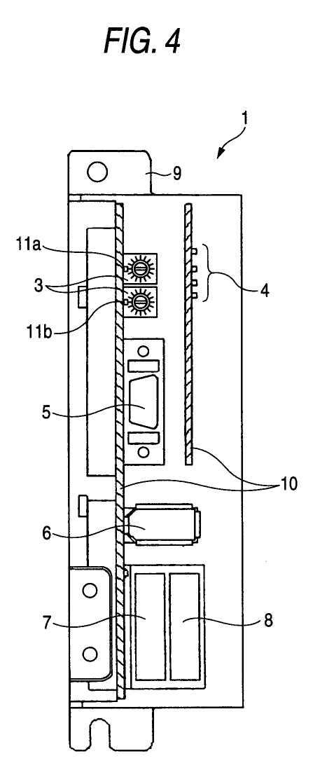

FIG. 4 is a front view of a state of removing a case of a motor control apparatus showing a second embodiment of the invention. In the drawing, numeral 1 designates the motor control apparatus, numeral 3 designates the setting switch, numeral 4 designates the state display, numeral 5 designates the input/output connector, numeral 6 designates the detector connector, numeral 7 designates the power source connector, numeral 8 designates the motor connector, numeral 9 designates the heat radiator, numeral 10 designates the board, numerals 11a, 11b designate the light illuminators. In the drawing, constituent elements of notations the same as those of FIG. 1 stay the same in operation thereof, and therefore, an explanation thereof will be omitted.

The light illuminators 11a, 11b are mounted on a part face of the power board mounted with the setting switch 3, and further facilitate to look at the graduations of the setting switches 3 by being mounted to be disposed in front of the graduation printing face of the setting switches 3. Further, the front view of the motor control apparatus 1 is covered by the case 2 to constitute the cabinet similar to the second background art of FIG. 6(a). In this case, the light illuminators 11a, 11b further facilitate to look at the graduations of the setting switch 3 by reducing leakage of a brightness of the light illuminators 11a, 11b to outside by being arranged at positions which are not seen directly from the front face. Further, the illuminators can ensure a necessary brightness by adjusting a number of mounting the illuminators as necessary. Further, the light illuminators 11a, 11b are mounted on the board at an immediate proximity of the setting switches 3, and therefore, the graduations of the setting switches 3 can be facilitated to look at without adding other board. Further, when the illuminance of the light illuminators 11a, 11b is sufficient for facilitating to see the graduations of the setting switch 3, the light illuminators 11a, 11b may not be arranged to be disposed in front of the graduation printing face of the setting switch 3.

### INDUSTRIAL APPLICABILITY

By a combination of mounting the light illuminator and an operating part of the setting switch or the like to the board, the optical recognizability can be promoted, and therefore, the invention is applicable to general electric control apparatus used under a dark environment.

1. A motor control apparatus comprising:
a switch setting portion for setting to switch a control constant of a control system in a motor control or a driving instruction condition from outside to control a motor on the basis of a set value set thereof;
a light illuminating portion for illuminating the switch setting portion;
a light illumination drive portion for driving the light illuminating portion; and
a control portion for controlling to drive and stop the light illumination drive portion.

2. The motor control apparatus according to claim 1, wherein
the control portion outputs a control signal to the light illumination drive portion based on a change in a set value of the switch setting portion.

3. The motor control apparatus according to claim 1, wherein
the control portion outputs a control signal of driving the light illumination drive portion during a previously set confirming time period immediately after inputting a power source of the motor control apparatus; and
the control signal for stopping the light illuminating portion is outputted after an elapse of the confirming time period.

4. The motor control apparatus according to claim 1, wherein
the control portion outputs a control signal for driving the light illumination drive portion during a previously set confirming time period after sensing a change in the set value of the switch setting portion; and
the control signal for stopping the light illuminating portion is outputted after an elapse of the confirming time period.

5. The motor control apparatus according to claim 1, wherein
the light illuminating portion is disposed at a vicinity of the switch setting portion for facilitating to see a character or a graduation.

6. The motor control apparatus according to claim 1, wherein
the light illuminating portion is disposed in front of a face of printing a character or a graduation of the switch setting portion.

7. The motor control apparatus according to claim 1, wherein
the light illuminating portion is disposed at a position which is not seen directly from a front face of the motor control apparatus.

8. The motor control apparatus according to claim 1, wherein
respective single pieces or pluralities of pieces of the light illuminating portions and the light illumination drive portions are provided for a number of the switch setting portions.
